(19) United States
(12) Patent Application Publication
(10) Pub. No.: US 2017/0199613 A1
(43) Pub. Date: Jul. 13, 2017

(54) TOUCH SCREEN CONTROLLER

(71) Applicant: eGalax_eMPIA Technology Inc., Taipei City (TW)

(72) Inventor: Po-Chuan LIN, Taipei City (TW)

(21) Appl. No.: 15/184,364

(22) Filed: Jun. 16, 2016

(30) Foreign Application Priority Data
Jan. 8, 2016 (TW) 105100545

(51) Int. Cl. G06F 3/041

(52) U.S. Cl. CPC G06F 3/0416

(57) ABSTRACT

A touch screen controller includes a driving circuit adapted for transmitting a high working voltage signal to the touch screen for enabling the touch screen to couple the high working voltage signal and to further generate a low working voltage signal, and a sensing circuit adapted for receiving the low working voltage signal from the touch screen for matching with the high working voltage signal to determine the variation in signal voltage between the high working voltage signal and the low working voltage signal and to further recognize a touch on the touch screen. The voltage level of the high working voltage signal provided by the driving circuit is five times over the voltage level of the low working voltage signal so that the sensing circuit can get the best signal-to-noise ratio, achieving optimal performance in touch control recognition.

This application claims the priority benefit of Taiwan patent application number 105100545, filed on Jan. 8, 2016.

### BACKGROUND OF THE INVENTION

1. Field of the Invention

The present invention relates to touch control technology and more particularly, to a touch screen controller, which comprises a driving circuit for transmitting a high working voltage signal to the touch screen for coupling, and a sensing circuit for receiving the coupled low working voltage signal from the touch screen for matching with the high working voltage signal to determine the signal voltage variation and to further recognize a touch on the touch screen. The voltage level of the high working voltage signal provided by the driving circuit is five times over the voltage level of the low working voltage signal so that the sensing circuit can get the best signal-to-noise ratio, achieving optimal performance in touch control recognition.

2. Description of the Related Art

With the development of the innovation of high technology electronic products, a variety of electronic products such as desk computers, notebook computers, mobile phones, auto teller machines, etc. have been created and widely used in our daily life. In the early days, most electronic products use a physical keyboard for the input of control instruction or signal to initiate system startup. However, some electronic products have a small size with minimized physical input keys. When clicking these minimized physical input keys, the user may inadvertently click a wrong key, leading to considerable trouble and inconvenience in input operation. In recent years, touch screen has been intensively used in smart electronic products such as smart phone, tablet computer, auto teller machine, commercial kiosk machine, etc. to substitute for physical keyboard for data input. A user can use a finger or stylus to touch a particular location within the display area of the touch screen, initiating an internal controller of the touch screen-based electronic product to run the related software. Commercial touch screens include two types, namely, the capacitive type and the resistive type. When a finger, stylus or any other conductive object touches or approaches the touch screen, the internal capacitive value of the touch screen is changed. This change in capacitive value is then detected by the internal controller for determination of the location of the touch on the touch screen and execution of the related action. The higher the voltage of the touch screen driving signal is the better the accuracy of the detection of the controller. If the voltage of the touch screen driving signal is low, the controller will be unable to accurately detect the touch on the touch screen, lowering touch control accuracy.

In order to increase the driving voltage of a touch screen driving signal, the driving circuit of a touch screen controller is normally made using a semiconductor high voltage manufacturing process for the output of a large amplitude driving signal. However, in order to save chip cost, the sensing circuit of a touch screen controller is normally made using a semiconductor low voltage manufacturing process. When a touch screen driving signal is coupled by the touch screen, it is attenuated. The attenuated touch screen sensing signal must be within the detectable voltage range of the sensing circuit that is made using a semiconductor low voltage manufacturing process. However, the voltage level of the driving circuit of a conventional touch screen controller is normally within 2˜5 times over the voltage level (≈3.3V) of the sensing circuit that is made using a semiconductor low voltage manufacturing process, or about 5V˜16V. Thus, the touch screen controller of a conventional touch screen cannot transmit a high working voltage signal. During the operation of a conventional touch screen to couple a high working voltage signal, surrounding noises can get into the signal, lowering the signal-to-noise ratio (SNR) of the signal detected by the touch screen controller and affecting the accuracy of the functioning of the touch screen controller in determining the location of the touch on the touch screen.

FIG. 8 illustrates the circuit architecture of a touch screen controller A. When the driving signal (TX) A1 outputs a high working voltage to the touch screen B, the high working voltage is coupled by the touch screen B and then detected by the sensing circuit of the touch screen controller A. The induction signal (RX) A2 thus detected by the sensing circuit of the touch screen controller A is greater than the voltage of the power source (VDD, LV) or lower than the earth ground voltage (GND). Thus, the high working voltage of the driving signal (TX) A1 triggers the low load voltage electrostatic discharge protection circuit (LV ESD), causing the induced sensing signal (RX) A2 to be released from the low load voltage electrostatic discharge protection circuit (LV ESD), and thus, the induced sensing signal (RX) A2 cannot be accurately transmitted to the controller A for computing, affecting the accuracy of the operation of the controller A in determining a touch on the touch screen B.

Therefore, it is desirable to provide a touch screen controller, which eliminates the problem of low touch determination accuracy due to insufficient sensing signal voltage and low signal-to-noise ration.

### SUMMARY OF THE INVENTION

The present invention has been accomplished under the circumstances in view. It is therefore the main object of the present invention to provide a touch screen controller, which is able to get the best signal-to-noise ratio, achieving optimal performance in touch control recognition.

To achieve this and other objects of the present invention, a touch screen controller comprises a driving circuit and a sensing circuit. The driving circuit is adapted for transmitting a high working voltage signal to the touch screen, enabling the touch screen to couple the high working voltage signal and to further generate a low working voltage signal. The sensing circuit is adapted for receiving the low working voltage signal from the touch screen for matching with the high working voltage signal to determine the variation in signal voltage between the high working voltage signal and the low working voltage signal and to further recognize a touch on the touch screen. The voltage level of the high working voltage signal provided by the driving circuit is five times over the voltage level of the low working voltage signal so as to get the best signal-to-noise ratio, achieving optimal performance in touch control recognition.

Further, the driving circuit of the controller is made through a semiconductor high voltage manufacturing process, such as drain extended metal oxide semiconductor (DEMOS), laterally diffused metal oxide semiconductor (LDMOS) or field drift metal oxide semiconductor (FDMOS) manufacturing process. In one embodiment of the present invention, the driving circuit comprises a digital-to-analog converter, a signal amplifier circuit, a signal selector switch and at least one high load voltage electrostatic discharge protection circuit. The digital-to-analog converter is adapted to receive a waveform control signal and to convert the waveform control signal into a digital signal, and then to transmit this digital signal to the signal amplifier circuit for amplification. The signal amplifier circuit is adapted to amplify the digital signal, and then to transmit the amplified digital signal to the signal selector switch for transmission to the touch screen through one of the at least one high load voltage electrostatic discharge protection circuit.

In another embodiment of the present invention, the driving circuit comprises at least one driving signal circuit. Each driving signal circuit comprises a voltage level shifter, a complementary metal oxide semiconductor transistor and a high load voltage electrostatic discharge protection circuit. The voltage level shifter is adapted to receive a low load voltage signal and to boost the low load voltage signal into a high load voltage signal, and then to transmit the high load voltage signal to the associating complementary metal oxide semiconductor transistor, enabling the associating complementary metal oxide semiconductor transistor to transmit the high load voltage signal through the associating high load voltage electrostatic discharge protection circuit to the touch screen.

In one embodiment of the present invention, the touch screen controller further comprises a chip core, a low load voltage electrostatic discharge protection circuit and a resistor. The resistor has one end thereof electrically connected to the touch screen and an opposite end thereof electrically connected to one end of the sensing circuit, which has an opposite end thereof electrically connected to one end of the low load voltage electrostatic discharge protection circuit, which has an opposite end thereof electrically connected to the chip core.

In another embodiment of the present invention, the touch screen controller further comprises a chip core, a low load voltage electrostatic discharge protection circuit and a resistor. The sensing circuit has one end thereof electrically connected to the touch screen and an opposite end thereof electrically connected to one end of the resistor, which has an opposite end thereof electrically connected to one end of the low load voltage electrostatic discharge protection circuit, which has an opposite end thereof electrically connected to the chip core.

In still another embodiment of the present invention, the touch screen controller further comprises a chip core, a first low load voltage electrostatic discharge protection circuit electrically connected to the chip core, a second low load voltage electrostatic discharge protection circuit electrically connected to the touch screen through the sensing circuit, and a resistor electrically connected in series between the first low load voltage electrostatic discharge protection circuit and the second low load voltage electrostatic discharge protection circuit.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a block diagram of the present invention.

FIG. 2 is a schematic simple structural view of a touch screen controller in accordance with the present invention.

FIG. 3 is a circuit diagram of the driving circuit of the touch screen controller in accordance with the present invention.

FIG. 4 is a circuit diagram of an alternate form of the driving circuit of the touch screen controller in accordance with the present invention.

FIG. 5 is a circuit diagram of the sensing circuit of the touch screen controller in accordance with the present invention.

FIG. 6 is a circuit diagram of an alternate form of the driving circuit of the touch screen controller in accordance with the present invention.

FIG. 7 is a circuit diagram of another alternate form of the driving circuit of the touch screen controller in accordance with the present invention.

FIG. 8 is a circuit diagram of a touch screen controller according to the prior art.

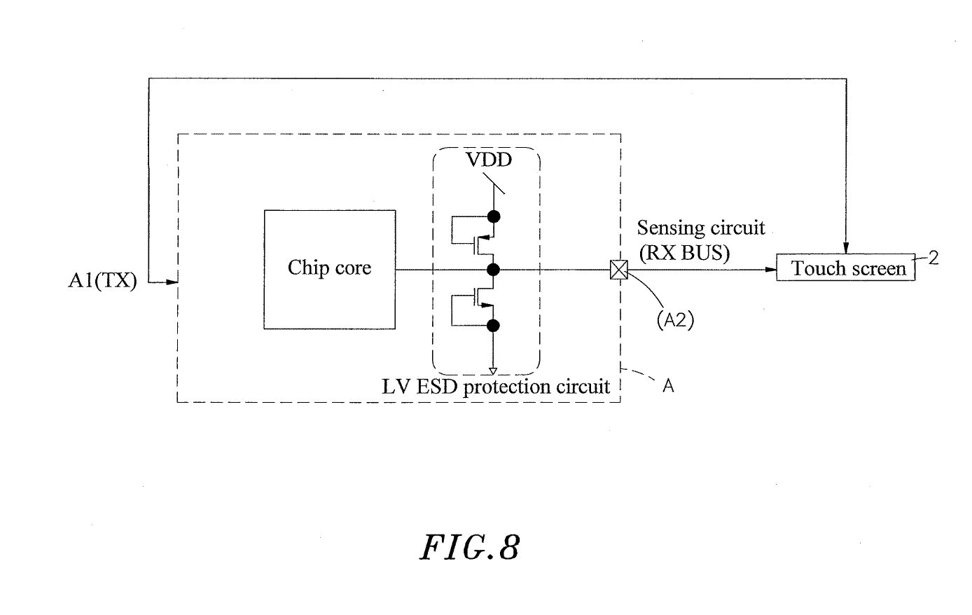

### DETAILED DESCRIPTION OF THE PREFERRED EMBODIMENT

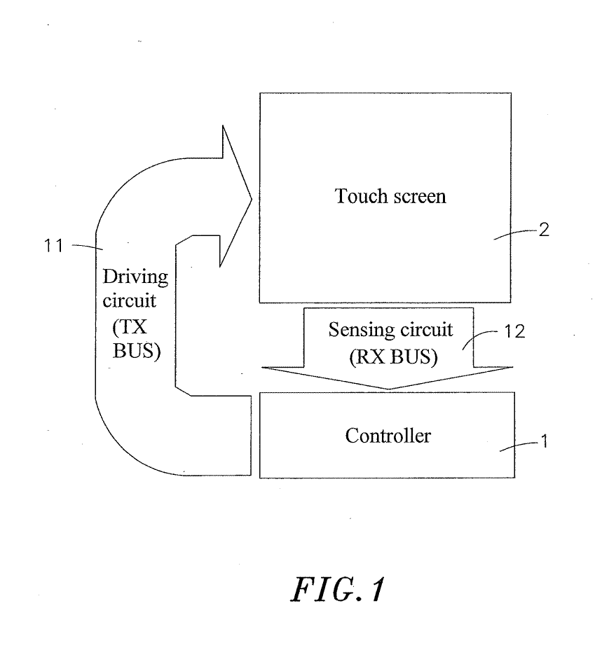

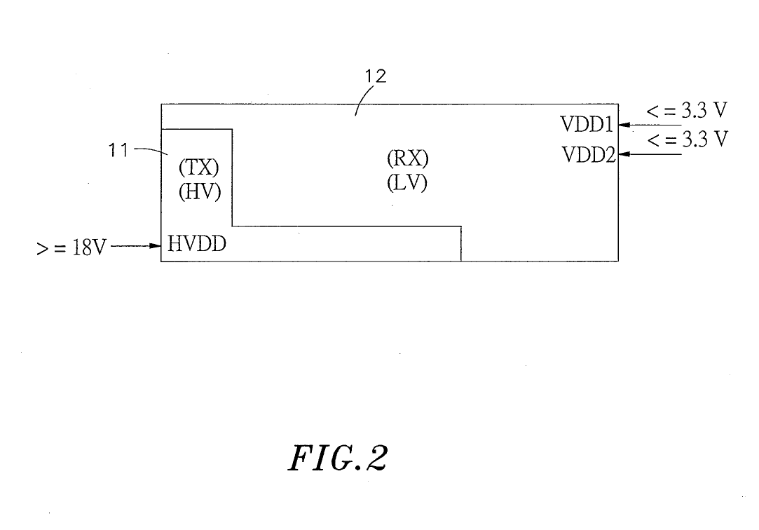

Referring to FIGS. 1 and 2, a controller 1 for use in a touch screen 2 in accordance with the present invention is shown. The controller 1 comprises a driving circuit (TX) 11 and a sensing circuit (RX) 12.

The driving circuit 11 of the controller 1 is made using a high-voltage semiconductor manufacturing process. The sensing circuit 12 of the controller 1 is made using a low-voltage semiconductor manufacturing process. The controller 1 uses the driving circuit 11 to provide a high working voltage to the touch screen 2, enabling a high voltage signal to go through the touch screen 2. Thereafter, the controller 1 controls the sensing circuit 12 to receive a detection signal from the touch screen 2, and then performs an algorithm to analyze signal variation for determination of any touch on the touch screen 2.

The driving circuit 11 of the controller 1 is made through a semiconductor high voltage manufacturing process, such as drain extended metal oxide semiconductor (DEMOS), laterally diffused metal oxide semiconductor (LDMOS) or field drift metal oxide semiconductor (FDMOS) manufacturing process, capable of transmitting a voltage source greater than or equal to 18 volts. The sensing circuit 12 of the controller 1 is made through a semiconductor low voltage manufacturing process, capable of transmitting a voltage source smaller than or equal to 3.3 volts. Thus, the voltage consumed by the driving circuit 11 that is made through a semiconductor high voltage manufacturing process is more than five times over the voltage consumed by the sensing circuit 12 that is made through a semiconductor low voltage manufacturing process, i.e., the driving circuit 11 is capable of transmitting a high working voltage greater than or equal to 18 volts to the touch screen 2. After having been coupled by the touch screen 2, the high working voltage is attenuated in the touch screen 2, and then the touch screen 2 outputs a working voltage signal that is then detected by the sensing circuit 12 of the controller 1. When the touch screen 2 couples the high working voltage that is transmitted by the driving circuit 11, surrounding noises can get into the working voltage signal, affecting the signal-to-noise ratio (SNR) of the sensing circuit 12, where:

SNR=P_{Signal}/P_{Noise}

Thus, if the driving circuit 11 of the controller 1 transmits a relatively higher working voltage signal (P_{Signal}) to the touch screen 2 for coupling, the working voltage signal with contained noises (P_{Noise}) received by the sensing circuit 12 from the touch screen 2 will have a better signal-to-noise ratio (SNR), enabling the controller 1 to determine the variation in signal voltage before and after a touch on the touch screen 2 accurately.

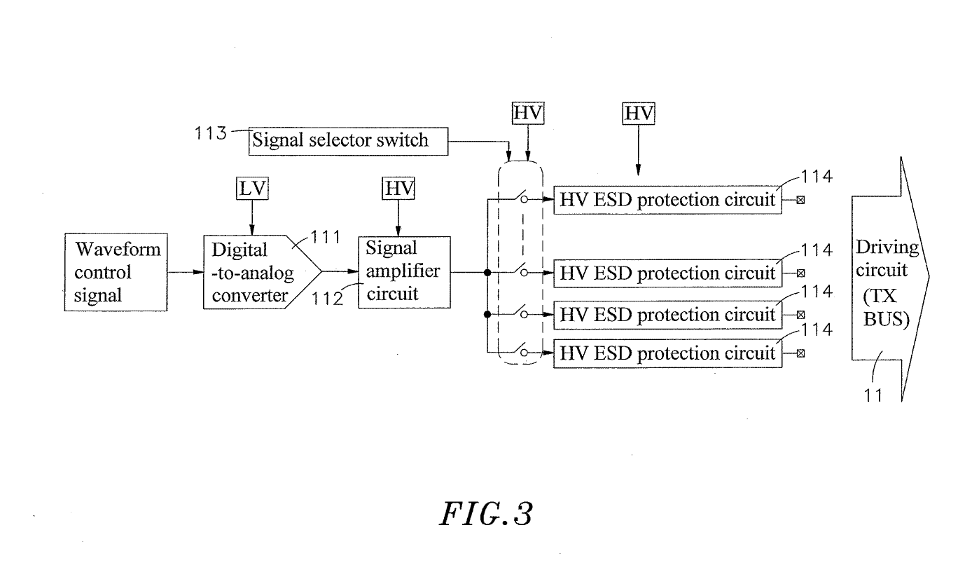

Referring to FIGS. 3 and 4 and FIG. 1 again, as stated above, the driving circuit 11 of the controller 1 made through a semiconductor high voltage manufacturing process. In one embodiment of the present invention, as shown in FIG. 3, the driving circuit 11 comprises a digital-to-analog converter (DAC) 111, a signal amplifier circuit 112, a signal selector switch 113 and at least one high load voltage electrostatic discharge (HLV ESD) protection circuit 114. The digital-to-analog converter (DAC) 111 receives a waveform control signal (TX) and converts it into a digital signal, and then transmits this digital signal to the signal amplifier circuit 112 for amplification, enabling the amplified signal to be then transmitted by the signal amplifier circuit 112 to the signal selector switch (TXMUX selector) 113 for further transmission to the touch screen 2 through one of the at least one high load voltage electrostatic discharge (HLV ESD) protection circuit 114. Thus, a high voltage signal can be transmitted through the driving circuit 11 to the touch screen 2.

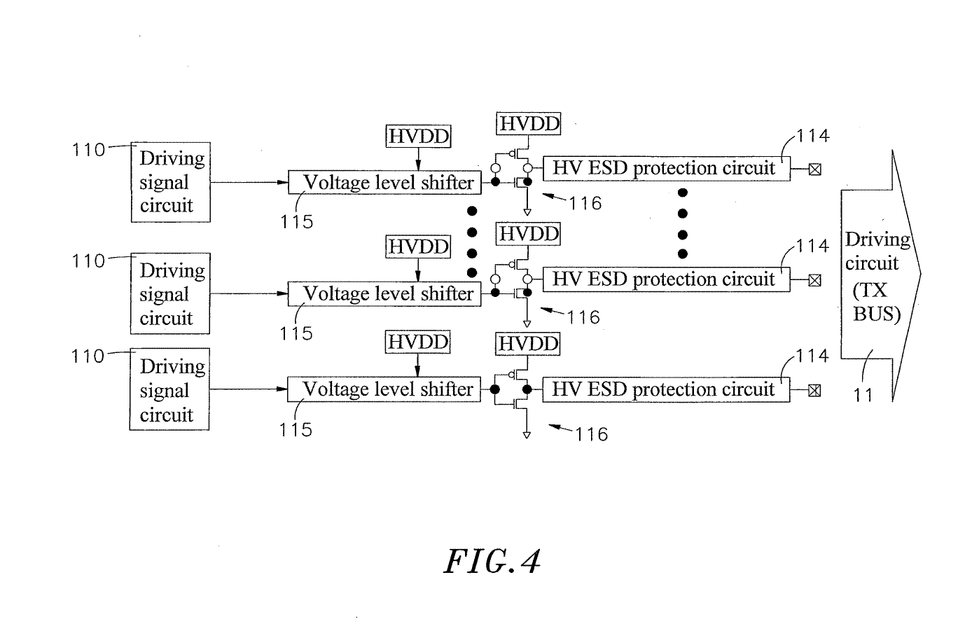

In another embodiment of the present invention, as shown in FIG. 4, the driving circuit 11 comprises at least one driving signal circuit 110. Each driving signal circuit 110 comprises a voltage level shifter 115, a complementary metal oxide semiconductor transistor 116 and a high load voltage electrostatic discharge protection circuit 114. The voltage level shifter 115 is adapted for receiving a low load voltage signal (TX LV) and boosting the voltage of the low load voltage signal (TX LV), and then transmitting the boosted signal to the associating complementary metal oxide semiconductor transistor 116. When the complementary metal oxide semiconductor transistor 116 receives a boosted signal from the associating voltage level shifter 115, it is triggered by the high voltage power source to transmit the signal through the associating high load voltage electrostatic discharge protection circuit 114, enabling the driving circuit 11 to provide the high working voltage to the touch screen 2.

Referring to FIGS. 5-7 and FIG. 1 again, the controller 1 uses the sensing circuit 12 to receive a working voltage signal from the touch screen 2. However, if the voltage of the received working voltage signal is higher than the working voltage of the sensing circuit 12, the working voltage signal can be missed by the low load voltage electrostatic discharge protection circuit (LV ESD), causing the controller 1 to receive an inaccurate working voltage signal. If this condition occurs, the controller 1 will be unable to compute the signal, or the computed result will be inaccurate. The sensing circuit 12 in accordance with the present invention uses a resistor 121 being connected thereto in series to drop the voltage so that the controller 1 can receive a working voltage signal from the touch screen 2 accurately. The sensing circuit 12 can be configured having a resistor 121 connected thereto in series in one of the configurations as follows:

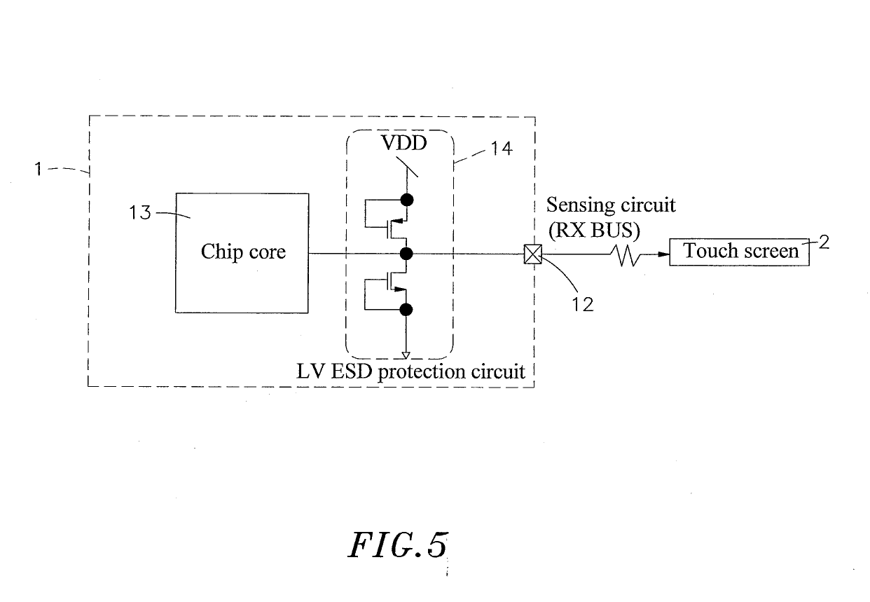

In one embodiment of the present invention, as shown in FIG. 5, the controller 1 comprises the aforesaid sensing circuit 12, a chip core 13, and a low load voltage electrostatic discharge (LV ESD) protection circuit 14. The sensing circuit 12 has one end thereof electrically connected in series to the touch screen 2 through a resistor 121 and an opposite end thereof electrically connected to the low load voltage electrostatic discharge (LV ESD) protection circuit 14 and then the chip core 13. When the controller 1 receives a working voltage signal from the touch screen 2 via the sensing circuit 12, the externally connected resistor 121 drops the voltage of the working voltage signal, making the amplitude of the working voltage signal to become in the range between the voltage of the low load voltage power source (LV VDD; equal to or smaller than 3.3 volts) and the earth ground voltage (GND) in conformity with the low-voltage semiconductor manufacturing process of the sensing circuit 12. After received a working voltage signal from the touch screen 2, the controller 1 matches the voltage of the working voltage signal been received from the touch screen 2 with the working voltage of the driving circuit 11 to determine the variation in signal voltage before and after a touch on the touch screen 2 accurately.

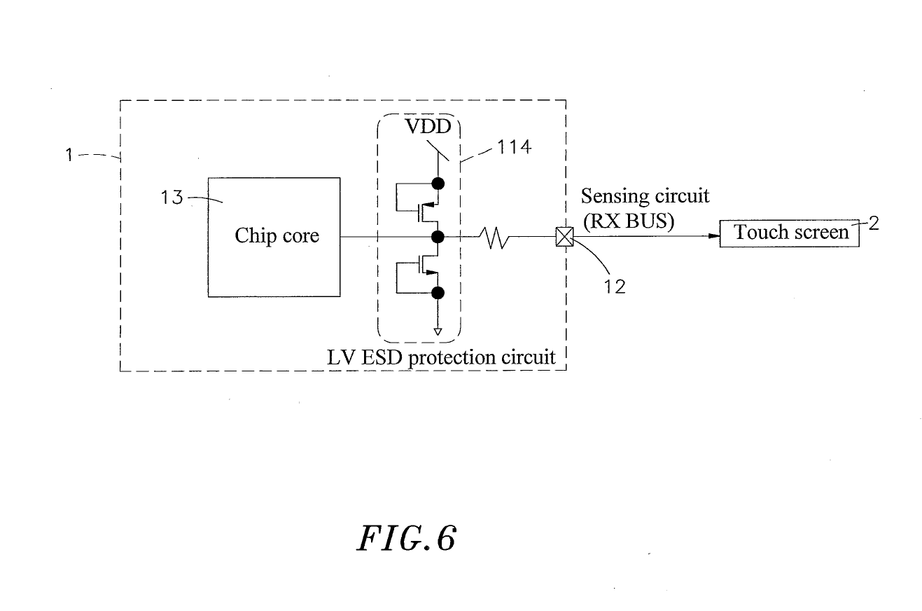

Further, in another embodiment of the present invention, as shown in FIG. 6, the controller 1 comprises the aforesaid sensing circuit 12, a chip core 13, a low load voltage electrostatic discharge (LV ESD) protection circuit 14, and a resistor 121 electrically connected in series between the low load voltage electrostatic discharge (LV ESD) protection circuit 14 and the sensing circuit 12. When the controller 1 receives a working voltage signal from the touch screen 2 via the sensing circuit 12, the internally connected resistor 121 drops the voltage of the working voltage signal, making the amplitude of the working voltage signal to become in the range between the voltage of the low load voltage power source (LV VDD; equal to or smaller than 3.3 volts) and the earth ground voltage (GND) in conformity with the low-voltage semiconductor manufacturing process of the sensing circuit 12. After received a working voltage signal from the touch screen 2, the controller 1 matches the voltage of the working voltage signal been received from the touch screen 2 with the working voltage of the driving circuit 11 to determine the variation in signal voltage before and after a touch on the touch screen 2 accurately.

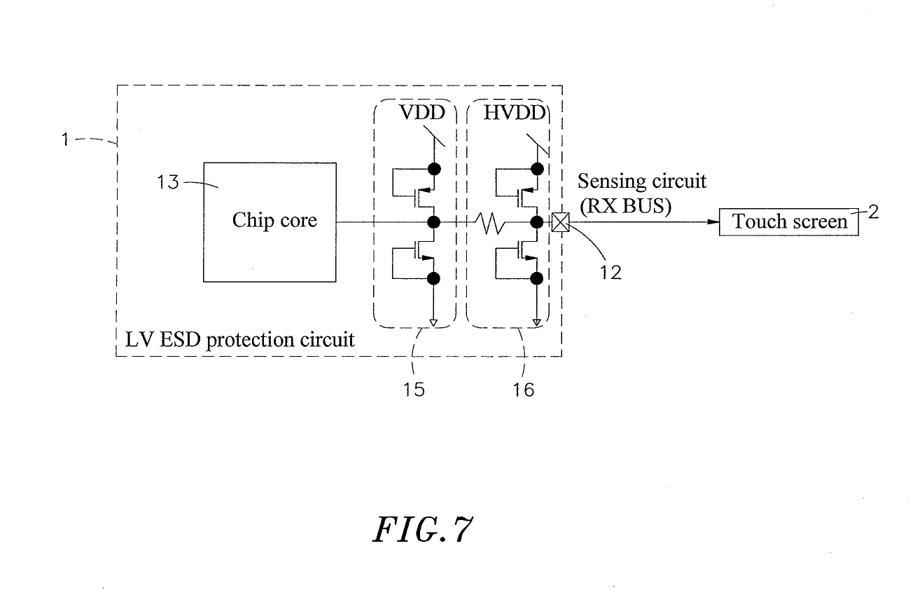

Further, in still another embodiment of the present invention, as shown in FIG. 7, the controller 1 comprises the aforesaid sensing circuit 12, a chip core 13, a first low load voltage electrostatic discharge (LV ESD) protection circuit 15 and a second low load voltage electrostatic discharge (LV ESD) protection circuit 16 electrically connected in series between the chip core 13 and the first low load voltage electrostatic discharge (LV ESD) protection circuit 15, and a resistor 121 electrically connected in series between the first low load voltage electrostatic discharge (LV ESD) protection circuit 15 and the second low load voltage electrostatic discharge (LV ESD) protection circuit 16. When the controller 1 receives a working voltage signal from the touch screen 2 via the sensing circuit 12, the internally connected resistor 121 that is electrically connected in series between the first low load voltage electrostatic discharge protection circuit (LV ESD circuit) 15 and the second low load voltage electrostatic discharge (LV ESD) protection circuit 16 drops the voltage of the working voltage signal, making the amplitude of the working voltage signal to become in the range between the voltage of the low load voltage power source (LV VDD; equal to or smaller than 3.3 volts) and the earth ground voltage (GND) in conformity with the low-voltage semiconductor manufacturing process of the sensing circuit 12. After received a working voltage signal from the touch screen 2, the controller 1 matches the voltage of the working voltage signal been received from the touch screen 2 with the working voltage of the driving circuit 11 to determine the variation in signal voltage before and after a touch on the touch screen 2 accurately.

In general, the touch screen controller 1 utilizes the driving circuit 11 that is made using a semiconductor high voltage manufacturing process to transmit a high working voltage signal to the touch screen 2 for coupling, and the sensing circuit 12 that is made using a semiconductor low voltage manufacturing process to receive a coupled low working voltage signal from the touch screen 2 for matching with the high working voltage signal to determine the signal voltage variation and to further recognize a touch on the touch screen 2. The voltage level of the high working voltage signal provided by the driving circuit 11 is five times over the voltage level of the low working voltage signal so that the sensing circuit 12 can get the best signal-to-noise ratio, achieving optimal performance in touch control recognition.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A controller used in a touch screen, comprising:
a driving circuit adapted for transmitting a high working voltage signal to said touch screen for enabling said touch screen to couple said high working voltage signal and to further generate a low working voltage signal; and
a sensing circuit adapted for receiving said low working voltage signal from said touch screen for matching with said high working voltage signal to determine the variation in signal voltage between said high working voltage signal and said low working voltage signal and to further recognize a touch on said touch screen;
wherein the voltage level of said high working voltage signal provided by said driving circuit is five times over the voltage level of said low working voltage signal.

2. The controller as claimed in claim 1, wherein said driving circuit comprises a digital-to-analog converter, a signal amplifier circuit, a signal selector switch and at least one high load voltage electrostatic discharge protection circuit, said digital-to-analog converter being adapted to receive a waveform control signal and to convert said waveform control signal into a digital signal, and then to transmit said digital signal to said signal amplifier circuit for amplification, said signal amplifier circuit being adapted to amplify said digital signal and then to transmit the amplified said digital signal to said signal selector switch for transmission to said touch screen through one of said at least one high load voltage electrostatic discharge protection circuit.

3. The controller as claimed in claim 1, wherein said driving circuit comprises at least one driving signal circuit, each said driving signal circuit comprising a voltage level shifter, a complementary metal oxide semiconductor transistor and a high load voltage electrostatic discharge protection circuit, said voltage level shifter being adapted to receive a low load voltage signal and to boost said low load voltage signal into a high load voltage signal and then to transmit said high load voltage signal to the associating said complementary metal oxide semiconductor transistor, enabling the associating said complementary metal oxide semiconductor transistor to transmit said high load voltage signal through the associating said high load voltage electrostatic discharge protection circuit to said touch screen.

4. The controller as claimed in claim 1, wherein said controller further comprises a chip core, a low load voltage electrostatic discharge protection circuit and a resistor, said resistor having one end thereof electrically connected to said touch screen and an opposite end thereof electrically connected to one end of said sensing circuit, said sensing circuit having an opposite end thereof electrically connected to one end of said low load voltage electrostatic discharge protection circuit, said low load voltage electrostatic discharge protection circuit having an opposite end thereof electrically connected to said chip core.

5. The controller as claimed in claim 1, wherein said controller further comprises a chip core, a low load voltage electrostatic discharge protection circuit and a resistor, said sensing circuit having one end thereof electrically connected to said touch screen and an opposite end thereof electrically connected to one end of said resistor, said resistor having an opposite end thereof electrically connected to one end of said low load voltage electrostatic discharge protection circuit, said low load voltage electrostatic discharge protection circuit having an opposite end thereof electrically connected to said chip core.

6. The controller as claimed in claim 1, wherein said controller further comprises a chip core, a first low load voltage electrostatic discharge protection circuit electrically connected to said chip core, a second low load voltage electrostatic discharge protection circuit electrically connected to said touch screen through said sensing circuit, and a resistor electrically connected in series between said first low load voltage electrostatic discharge protection circuit and said second low load voltage electrostatic discharge protection circuit.

7. The controller as claimed in claim 1, wherein said driving circuit is electrically connected to an external power source of voltage equal to or greater than 18 volts; said sensing circuit is electrically connected to an external power source of voltage equal to or smaller than 3.3 volts.
